(19) United States
(12) Patent Application Publication
(10) Pub. No.: US 2016/0139726 A1
(43) Pub. Date: May 19, 2016

(54) LOW LATENCY TOUCH DISPLAY DEVICE AND DRIVING METHOD THEREOF

(71) Applicant: Samsung Display Co., Ltd., Yongin-city (KR)

(72) Inventors: Seung Woo Lee, Daegu (KR); Geun Young Jeong, Busan (KR)

(21) Appl. No.: 14/730,936

(22) Filed: Jun. 4, 2015

(30) Foreign Application Priority Data
Nov. 18, 2014 (KR) 10-2014-0160949

(51) Int. Cl. G06F 3/041

(52) U.S. Cl. CPC G06F 3/0416

(57) ABSTRACT

A touch display device includes: an image display unit including a plurality of pixels; a touch sensor for sensing a user's touch input; a first memory for storing data per display frame; and a controller for, when a pixel group including at least one pixel is selected according to a position of a touch input sensed by the touch sensor and data corresponding to the pixel group is not read from the first memory, updating data corresponding to the pixel group based on the data caused by the touch input.

### CROSS REFERENCE TO RELATED APPLICATION

This application claims priority from and the benefit of Korean Patent Application No. 10-2014-0160949, filed on Nov. 18, 2014, which is hereby incorporated by reference for all purposes as if fully set forth herein.

### BACKGROUND

1. Field

Exemplary embodiments of the present invention relate to a touch display device, and in particular, relate to a low-latency touch display device having reduced display lag between a touch sensor and an image display unit, and a driving method thereof.

2. Discussion of the Background

A data flow of a touch display device including a touch screen panel (TSP) will be generally described.

A user's touch input is received through a touch sensor, and the touch input is processed by an application processor (AP). An operating system and an application are operated by the application processor. Processed touch information is combined with a still image or a motion picture and is then output to an image display unit.

During the process, at least 100 ms passes before a user's touch input is visibly output. In general, a user is able to recognize a time lag around the time of 30 ms. As a result, when the above-noted data processing is performed, the user recognizes that a touch reaction is delayed.

Therefore, it is important to minimize the display lag from the touch input to a touch information output.

To minimize the display lag, a technique for immediately visualizing a touch input and outputting a visualized touch input with a default value when it is input by a user has been developed. The technique reduces the display lag since it immediately visualizes the touch input with a predetermined default value without undergoing the processing by the application processor.

The technique generally reduces the display lag by overlaying the image on the touch input.

However, the lag-reducing technique cannot be used in all cases. That is, processing by the application processor may be necessary depending on different types of touch information, which therefore fails to reduce the display lag in all cases.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the present invention disclose a touch display device for immediately applying a user's touch input to a display frame.

Additional features of the invention will be set forth in the description which follows, and in part will be apparent from the description, or may be learned by practice of the invention.

An exemplary embodiment of the present invention discloses a touch display device, including: an image display unit includes a plurality of pixels; a touch sensor for sensing a user's touch input; a first memory for storing data per display frame; and a controller for, when a pixel group including at least one pixel is selected according to a position of a touch input sensed by the touch sensor and data that correspond to the pixel group are not read from the first memory, updating data that correspond to the pixel group based on the data caused by the touch input.

An exemplary embodiment of the present invention also discloses a method for driving a touch display device, including: receiving a user's touch input; selecting a pixel group including at least one pixel according to a position of the touch input; when data that correspond to the pixel group are not read from a first memory, updating the data that correspond to the pixel group in a present display frame; when data that correspond to the pixel group are read from the first memory, updating the data that correspond to the pixel group in a subsequent present display frame; and reading the data of the present display frame and outputting the same as an image by an image display unit.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 shows a schematic diagram of a touch display device according to an exemplary embodiment of the present invention.

FIG. 2 shows a memory reading position and a touch input position according to an exemplary embodiment of the present invention.

FIG. 3 shows a timing diagram for indicating a relative position of a control signal in an exemplary embodiment of FIG. 2.

FIG. 4 shows a memory reading position and a touch input position according to another exemplary embodiment.

FIG. 5 shows a timing diagram for indicating a relative position of a control signal in an exemplary embodiment of FIG. 4.

FIG. 6 shows a flowchart of a method for driving a touch display device according to an exemplary embodiment of the present invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof

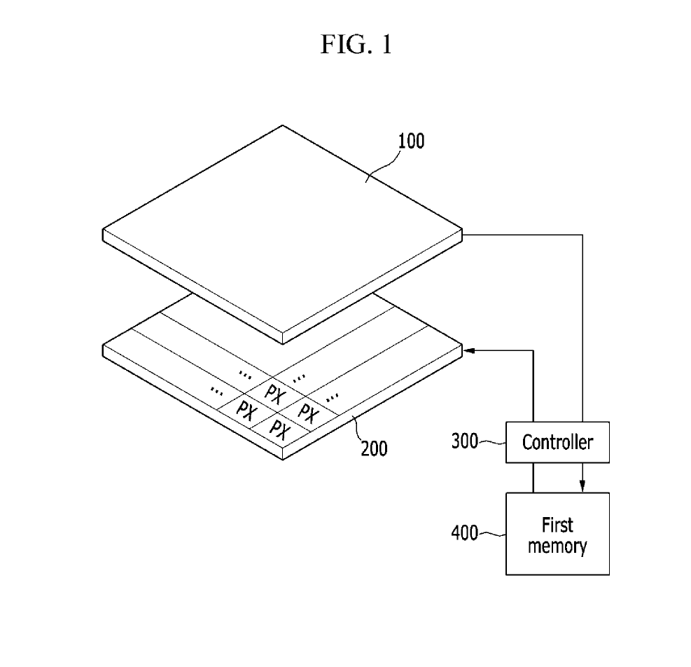

FIG. 1 shows a schematic diagram of a touch display device according to an exemplary embodiment of the present invention.

Referring to FIG. 1, the touch display device includes a touch sensor 100, an image display unit 200, and a first memory 400.

Touch sensing by the touch sensor 100 is realized through a sensor. The sensor is classified according to various methods including a resistive type, a capacitive type, an electro-magnetic (EM) type, and an optical type, but is not limited thereto.

The image display unit 200 includes any type of display device. The display unit 100 includes any type of devices for outputting still images or motion pictures recognizable by viewers such as a plasma display, a liquid crystal display (LCD), a light emitting diode (LED) display, and an organic light emitting diode (OLED) display.

The image display unit 200 includes a plurality of pixels PX. The pixels PX are arranged in a matrix form.

The touch sensor 100 and the image display unit 200 may be integrally formed.

The first memory 400 includes any type of memory device. The memory device may be a volatile memory device and/or a non-volatile memory device. The volatile memory device may be a memory device for deleting stored data when power is no longer supplied. The volatile memory device may be, for example, a static RAM (SRAM), a dynamic RAM (DRAM), and a synchronous DRAM (SDRAM).

In the present specification, a DDR-SDRAM available for simultaneous reading and writing will be described as a reference, but other configurations are contemplated. For example, in the case of a memory that is inappropriate for performing simultaneous reading and writing, exemplary embodiments of the present invention are realizable by using an additional buffer (i.e., a second memory).

The memory is applicable to a wide range of usage depending on its role in the device, and the first memory 400 according to an exemplary embodiment of the present invention may be used as a frame buffer. Hence, the first memory 400 may store a display frame to be output to the image display unit 200.

The second memory may be a line buffer for storing the data of the display frame of the first memory for respective lines. The lines in this case may be singular or plural. The image display unit 200 reads data not from the first memory 400 but from the second memory, and outputs the same as an image.

The respective data configuring the display frame may correspond to the respective pixels of the image display unit. The data may indicate gray values of the pixels. The correspondence relationship may depend on the types of display device and the associated rendering. For ease of description, a case where the data matches the pixels respectively will be referred to. In this case, positions of the data may be determined by positions of the pixels.

A controller 300 may update the data stored in the first memory according to a condition. The condition represents a state in which the data corresponding to a pixel group are read from the first memory 400. The condition also may indicate a state of whether the data corresponding to the first pixel is read from the first memory 400. As described above, the second memory rather than the first memory may be usable as a reference.

The updated data may represent data that correspond to the pixel group. For example, when the user generates a touch through a writing trace, the data is updated by overlaying the writing trace data caused by a touch input on the existing image data of the pixel group.

The controller 300 may include a driver IC, a touch IC, a timing controller, a gate driver, a source driver, an application processor, and a memory for processing an image. This is merely exemplary and the invention is not limited thereto.

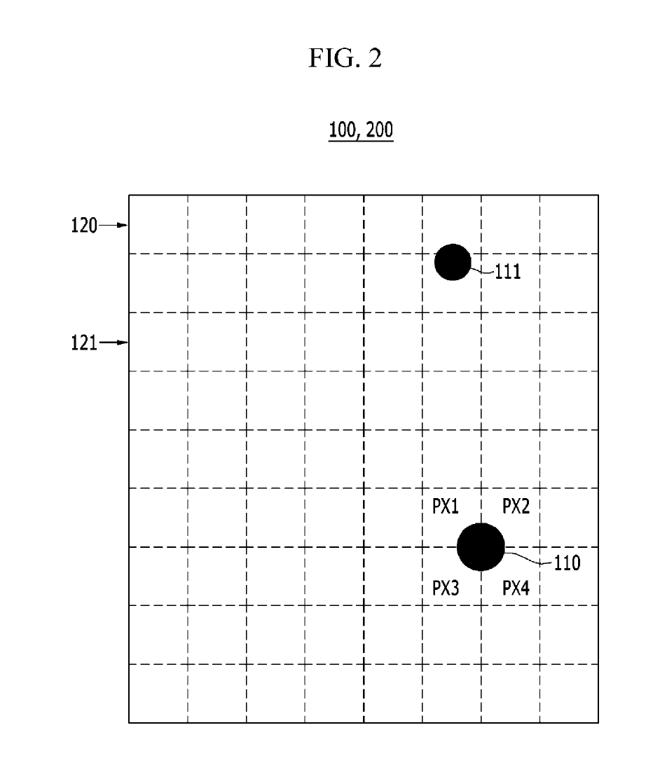

FIG. 2 shows a memory reading position and a touch input position according to an exemplary embodiment of the present invention.

FIG. 2 shows a plan view of the touch sensor 100. A Tx electrode (not shown) and an Rx electrode (not shown) included in the touch sensor 100 may be transparent electrodes such as indium tin oxide (ITO) so the image display unit 200 is shown as overlapping the touch sensor 100.

Respective quadrangles divided by horizontal and vertical dotted lines of FIG. 2 indicate respective pixels (PX1, PX2, PX3, PX4, . . . ) of the image display unit 200.

Sensed ranges when a touch induced by the user's finger is sensed on the touch sensor 100 are referred to as touch inputs 110 and 111. Referring to FIG. 2, a case in which the touch input 111 is sensed at a top of the touch sensor 100 and a case in which the touch input 110 is sensed at a bottom of the touch sensor 100 are shown.

In the exemplary embodiment of FIG. 2, for ease of description, a case in which the touch input 110 and the touch input 111 are simultaneously performed is excluded, and a case in which the touch input 110 is performed and a case in which the touch input 111 is performed will be described.

In this instance, in the case of the touch input 110, a pixel group configured with four pixels PX1, PX2, PX3, and PX4 is selected.

A memory reading position 121 signifies a position where data of a display frame are read from the first memory 400.

A memory reading start position 120 signifies the position of initial data where the display frame is read.

In the exemplary embodiment of FIG. 2, the data of the first memory 400 may be sequentially read in a first direction. The memory reading start position 120 can be a first row. The present memory reading position 121 at this time is a third row. Therefore, the first direction goes from an upper row to a lower row. However, it is contemplated that reading the display frame stored in the first memory 400 may be modified in various ways.

In the case of the touch input 110, the pixels PX1 and PX2 that are read first with reference to the first direction may be referred to as first pixels.

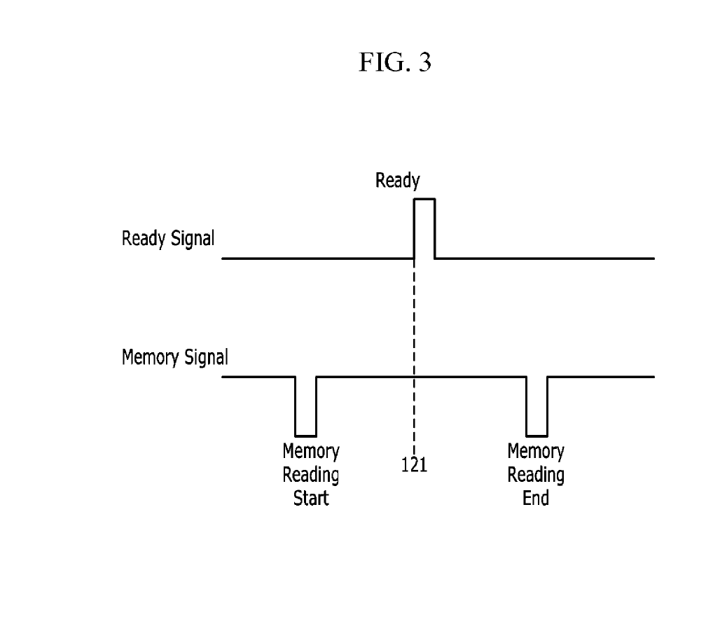

FIG. 3 shows a timing diagram for indicating a relative position of a control signal in an exemplary embodiment of FIG. 2.

Referring to FIG. 3, a touch frame ready signal (Ready Signal) and a memory reading signal (Memory Signal) are shown.

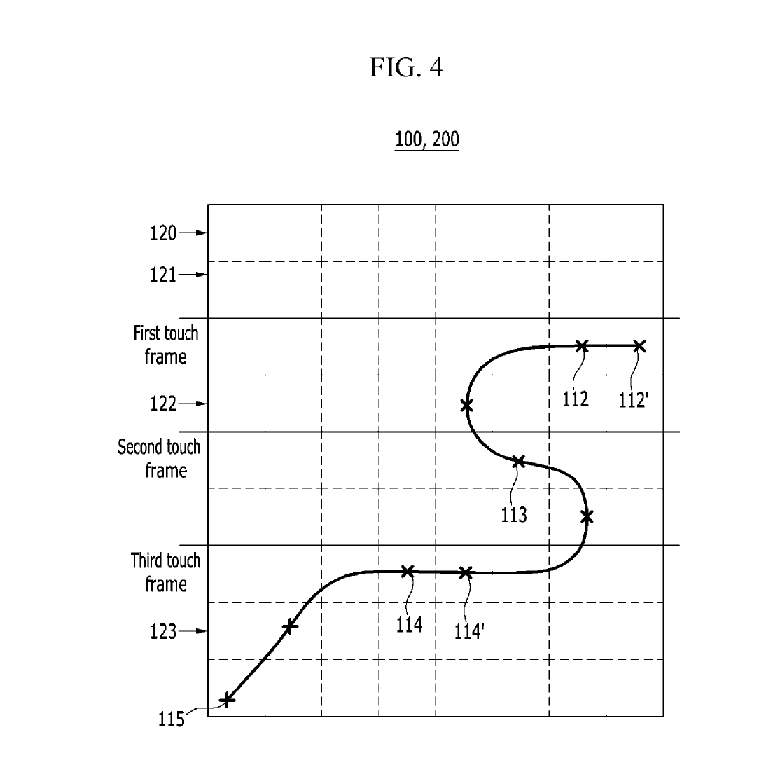

A touch frame and a display frame will be described later with reference to the exemplary embodiment of FIG. 4. The exemplary embodiment of FIG. 3, for ease of description, will be described with reference to a single touch frame.

A case in which the touch input 110 is performed will now be described. When the touch frame in which the touch input 110 is generated is finished, a touch frame ready pulse (Ready) may occur.

When the touch frame ready pulse (Ready) is generated, the memory reading position 121 is a third row as shown in FIG. 2. Hence, the data that correspond to the pixel group according to the position of the touch input 110 is not yet read.

The updated data may be read by updating the data that corresponds to the selected pixel group. As the updated data is read, the user's touch is immediately applied in the present display frame.

As described above, the present exemplary embodiment will be described with reference to the DDR-SDRAM that is simultaneously readable and writable. However, in the case of a memory which is not simultaneously readable and writable, exemplary embodiments of the present invention may be realizable by using, for example, an additional buffer (i.e., a second memory).

In comparative embodiments, the data of the display frame that has started being read is not updated so the touch input that is input in the present display frame may be applicable in the next display frame. However, in exemplary embodiments of the present invention a display device driven at 60 Hz may reduce display lag to be less than 16.67 ms (the length one frame).

Referring to FIGS. 2 and 3, the case in which the touch input 111 is generated will now be described. When the touch frame in which the touch input 111 is generated is finished, a touch frame ready pulse (Ready) is generated.

When the touch frame ready pulse (Ready) occurs, the memory reading position 121 is the third row as shown in FIG. 2. Therefore, the data that correspond to the pixel group selected according to the position of the touch input 111 is already read.

The data that corresponds to the selected pixel group is updated in the coming display frame.

FIG. 4 shows a memory reading position and a touch input position according to an exemplary embodiment.

In a like manner of the exemplary embodiment of FIG. 2, the touch sensor 100 is shown to overlap the image display unit 200 in the exemplary embodiment of FIG. 4.

FIG. 4 shows a case in which the user draws a line and generates a touch input. The user inputs a writing trace from a pixel 112 to a pixel 115 in the manner shown in FIG. 4.

The touch frame is independently driven from the display frame. For convenience of description, a period of the touch frame is described to be less than that of the display frame in exemplary embodiments of the present invention. The touch frame is driven at 90-100 Hz and the display frame is driven at 60 Hz. Therefore, at least one touch frame is temporally provided in the display frame.

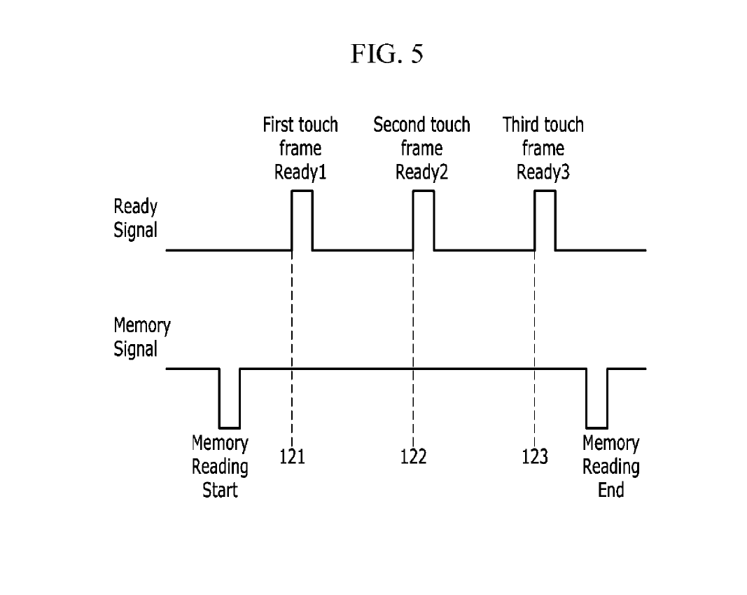

The touch frame signifies a unit of time to scan a region of the touch sensor 100. Hence, a first touch frame, a second touch frame, and a third touch frame appear for convenience of explanation as if they are separated in a spatial manner in FIG. 4, but they are not. The touch frames may be identical with a predetermined region, for example, a region that corresponds to the image display unit 200, and may be different from the same in a temporal manner, so they are numbered with as first, second, and third touch frames (see FIG. 5).

The first touch frame, the second touch frame, and the third touch frame in FIG. 4 are divided by the touch inputs in respective touch frame sections.

The pixel groups respectively correspond to the touch frames. In the example shown in FIG. 4, the first touch frame may correspond to the pixel group having three pixels, the second touch frame may correspond to the pixel group having two pixels, and the third touch frame may correspond to the pixel group having four pixels.

A portion where the user's touch input is not recognizable is interpolated.

In the exemplary embodiment of FIG. 4, the memory reading start position 120 is the first row, and the present memory reading position 121 is the second row. Therefore, the first direction goes toward the lower row from the upper row.

The first pixels of the pixel group of the first touch frame are pixels 112 and 112′, the first pixel of the pixel group of the second touch frame is pixel 113, and the first pixels of the pixel group of the third touch frame are pixels 114 and 114′.

When the data corresponding to the above-noted first pixels is not yet read from the first memory 400, the data corresponding to the pixel group is updated in the present display frame.

When the data corresponding to the above-noted first pixels is already read from the first memory 400, the data corresponding to the pixel group is updated in the next display frame.

FIG. 5 shows a timing diagram for indicating a relative position of a control signal in an exemplary embodiment of FIG. 4.

Referring to FIG. 5, a touch frame ready signal (Ready Signal) and a memory reading signal (Memory Signal) for the first touch frame, the second touch frame, and the third touch frame are shown.

When a touch frame ready pulse (Ready 1) of the first touch frame is generated, the memory reading position 121 is the second row as shown in FIG. 4. The first pixels 112 and 112′ of the pixel group of the first touch frame are provided in the third row so the pixel group of the first touch frame is not yet read from the first memory 400.

Therefore, the data that corresponds to the pixel group of the first touch frame is updated in the present display frame.

When a touch frame ready pulse (Ready 2) of the second touch frame is generated, a memory reading position 122 is the fourth row as shown in FIG. 4. The first pixel 113 of the pixel group of the second touch frame is provided in the fifth row so the pixel group of the second touch frame is not yet read from the first memory 400.

Therefore, the data that correspond to the pixel group of the second touch frame are updated in the present display frame.

When a touch frame ready pulse (Ready 3) of the third touch frame is generated, a memory reading position 123 is the eighth row as shown in FIG. 4. The first pixels 114 and 114′ of the pixel group of the third touch frame are provided in the seventh row so at least one of the pixels configuring the pixel group of the third touch frame is read from the first memory 400.

Therefore, the data that corresponds to the pixel group of the third touch frame is updated in the subsequent display frame.

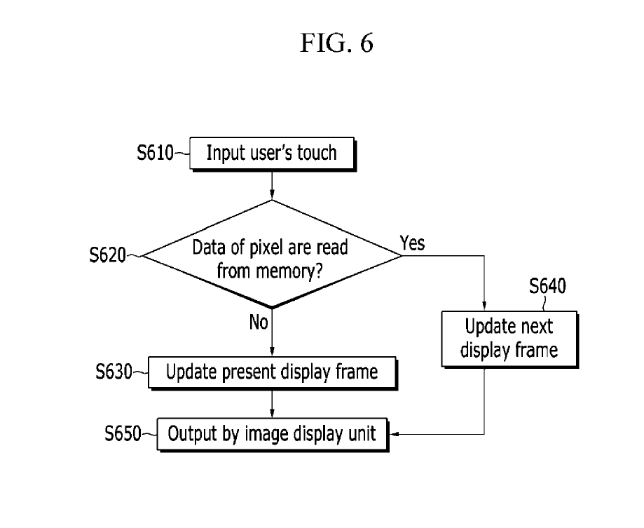

FIG. 6 shows a flowchart of a method for driving a touch display device according to an exemplary embodiment of the present invention.

A user's touch input is sensed by the touch sensor 100 (S610).

Rates of the display frame and the touch frame may be variable by a touch report rate and a display refresh rate of the touch sensor 100. The touch frame may be driven in synchronization with a horizontal synchronization period Hsync or a vertical synchronization period Vsync.

It is determined whether the data of the pixel is read from a memory (S620). As described in the above-noted exemplary embodiments, when the corresponding touch frame is ready, the first pixel of the pixel group may be provided after the position where the present memory is read with reference to the first direction in which the data is read. That is, the first pixel may not have been read from the present memory.

In this case, it may be determined that the output of the image display unit 200 can be immediately updated when the pixel group of the corresponding touch frame is updated in the present display frame. Therefore, it is updated by applying the data having the modified present display frame (S630).

However, when the first pixel is already read from the memory and the pixel group of the corresponding touch frame is updated in the present display frame, it may be determined that the output of the image display unit 200 is not immediately updated. Hence, the modified data is updated not in the present display frame but in the next display frame (S640).

The present display frame that is updated in S630 or that is not updated in S640 is output by the image display unit (S650).

According to exemplary embodiments, controllers, such as timing controllers, gate drivers, and/or data drivers, and the like, may be implemented via one or more general purpose and/or special purpose components, such as one or more discrete circuits, digital signal processing chips, integrated circuits, application specific integrated circuits, microprocessors, processors, programmable arrays, field programmable arrays, instruction set processors, and/or the like.

According to exemplary embodiments, the processes described herein to facilitate image signal processing and the display of images via image display unit 200 may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. In this manner, the display device including image display unit 200 may include or otherwise be associated with one or more memories including code (e.g., instructions) configured to cause the image display unit 200 to perform one or more of the processes and/or features described herein.

The memories described herein may be any non-transitory medium that participates in providing code/instructions to the one or more software, hardware, and/or firmware for execution. Such memories may take many forms, including but not limited to non-volatile media and volatile media. Non-volatile media include, for example, optical or magnetic disks. Volatile media include dynamic memory. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, or any other medium from which a computer can read.

The accompanying drawings and the exemplary embodiments of the present invention are only examples of the present invention, and are used to describe the present invention but do not limit the scope of the present invention as defined by the following claims. Thus, it will be understood by those of ordinary skill in the art that various modifications and equivalent embodiments may be made. Therefore, the technical scope of the present invention may be defined by the technical idea of the following clams.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A touch display device, comprising:
an image display unit comprising pixels;
a touch sensor configured to sense a user's touch input;
a first memory configured to store first data for each display frame; and
a controller configured to update the first data corresponding to a pixel group, the pixel group determined based on second data caused by the touch input and including at least one pixel, when the pixel group is selected according to a position of a touch input sensed by the touch sensor and the first data corresponding to the pixel group has not been read from the first memory.

2. The touch display device of claim 1, wherein
when the first data corresponding to the pixel group has already been read from the first memory, the data corresponding to the pixel group is updated by the controller in a subsequent display frame.

3. The touch display device of claim 1, wherein
the first data is sequentially read from the first memory in a pixel first direction,
at least one touch frame is temporally provided in the display frame,
the pixel group is sensed in the touch frame,
the pixel group comprises a plurality of pixels,
a first pixel of the pixel group is determined with respect to the first direction, and
when the first data corresponding to the first pixel has not been read from the first memory, the first data corresponding to the pixel group is updated using the second data from the user's touch input.

4. The touch display device of claim 3, wherein
when the first data corresponding to the first pixel has already been read from the first memory, the first data that correspond to the pixel group is updated in a next display frame using the second data from the user's touch input.

5. The touch display device of claim 3, wherein
the pixel group comprises a plurality of pixel groups, and
each pixel group of the plurality of pixel groups respectively corresponds to a different touch frame.

6. The touch display device of claim 3, wherein
the touch display device further comprises a second memory,
the first memory outputs at least part of the first data to the second memory, and
when the first data corresponding to the first pixel has not been read from the second memory, at least part of the first data corresponding to the pixel group is updated using the second data from the user's touch input.

7. The touch display device of claim 6, wherein
when the first data corresponding to the first pixel has already been read from the second memory, at least part of the first data corresponding to the pixel group is updated in the next display frame using the second data from the user's touch input.

8. The touch display device of claim 6, wherein
the second memory comprises a plurality of memory units.

9. A method for driving a touch display device, comprising:
receiving a user's touch input;
selecting a pixel group comprising at least one pixel according to a position of the touch input;
updating first data corresponding to the pixel group in a present display frame using second data from the user's touch input when the first data that corresponds to the pixel group has not been read from a first memory;
updating the first data corresponding to the pixel group in a subsequent display frame using the second data from the user's touch input when data corresponding to the pixel group has already been read from the first memory;
reading the first data of the present display frame; and
outputting the first data of the present display frame as an image.

10. The method of claim 9, wherein
the first data are sequentially read from the first memory in a first direction,
at least one touch frame is temporally provided in the display frame,
the pixel group is sensed by the touch frame,
the pixel group comprises a plurality of pixels,
a first pixel of the pixel group is determined with respect to the first direction, and
updating the first data further comprises:
updating the first data corresponding to the pixel group in the present display frame using the second data from the user's touch input when the first data corresponding to the first pixel has not yet been read from the first memory; and
updating the first data corresponding to the pixel group in the subsequent display frame using the second data from the user's touch input when the data corresponding to the first pixel has already been read from the first memory.

11. The method of claim 10, wherein
the pixel group comprises a plurality of pixel groups, and
each pixel group of the plurality of pixel groups respectively corresponds to a different touch frame.

12. The method of claim 10, further comprising:
outputting, from the first memory, at least part of the display frame to a second memory,
wherein the updating the first data comprises,
updating at least part of the first data corresponding to the pixel group in the present display frame using the second data from the user's touch input when the first data corresponding to the first pixel has not yet been read from the second memory,
updating at least part of the data corresponding to the pixel group in the subsequent display frame using the second data from the user's touch input when the data that correspond to the first pixel has already been read from the second memory.

13. The method of claim 12, wherein
the second memory comprises a plurality of memory units.
